(19) United States
(12) Patent Application Publication
(10) Pub. No.: US 2017/0148136 A1
(43) Pub. Date: May 25, 2017

(54) APPARATUS AND METHOD FOR GENERATING PERIPHERAL IMAGE OF VEHICLE

(71) Applicants: Wise Automotive Corporation, Seoul (KR); SL Corporation, Gyeongangbuk-do (KR)

(72) Inventors: Jung-Pyo Lee, Gyeonggi-do (KR); Choon-Woo Ryu, Incheon (KR); Jae-Hong Park, Seoul (KR)

(21) Appl. No.: 15/277,017

(22) PCT Filed: Apr. 3, 2015
(86) PCT No.: PCT/KR2015/003395

§ 371 Date: Sep. 27, 2016

(30) Foreign Application Priority Data
Apr. 4, 2014 (KR) 10-2014-0040632

(51) Int. Cl. G06T 3/00; B60R 11/04; H04N 7/18; B60R 1/00

(52) U.S. Cl. CPC G06T 3/0087; B60R 1/002; B60R 11/04; H04N 7/183; B60R 2300/607; B60R 2300/30; B60R 2300/802; G06T 2200/32; G08G 1/167

(57) ABSTRACT

This application relates to an apparatus and a method for creating an image of the area around a vehicle. The apparatus for creating an image of an area around a vehicle according to this application includes: a camera unit that creates an image of a peripheral area; an aerial-view image creation unit that creates an aerial-view image by converting a view point of the taken image; a movement information extraction unit that extracts information about movement of the vehicle; a movement-area aerial-view image creation unit that creates a movement-area aerial-view image, which is an aerial view of the area to which the vehicle has moved; and a combined aerial-view image creation unit that combines an aerial-view image subsequent to the previous aerial-view image with the movement-area aerial-view image.

### CROSS-REFERENCE TO RELATED APPLICATIONS

This application is a national phase entry under 35 U.S.C. §371 of International Patent Application PCT/KR2015/003395, filed Apr. 3, 2015, designating the United States of America and published as International Patent Publication WO 2015/152692 A1 on Oct. 8, 2015, which claims the benefit under Article 8 of the Patent Cooperation Treaty to Korean Patent Application Serial No. 10-2014-0040632, filed Apr. 4, 2014.

### TECHNICAL FIELD

The present disclosure relates to an apparatus and method for peripheral image generation of a vehicle. In particular, the present disclosure relates to an apparatus and a method for creating an image of the area around a vehicle to obtain an image behind the vehicle and display the image on a monitor.

### BACKGROUND

In general, a vehicle is a machine that transports people or freight or performs various jobs while running on roads using a motor, such as an engine, therein as a power source, and a driver that is supposed to safely drive a vehicle while viewing the forward area.

However, a driver has difficulty viewing the area behind the vehicle when driving the vehicle backward, for example, when parking. Accordingly, a display device that outputs images from a camera on the rear part of a vehicle on a monitor has been used as a device for displaying the area behind a vehicle.

In particular, a technology that can accurately determine the relative position between a vehicle and a parking spot in an image displayed on a monitor through a technology of changing an input image from a camera into an aerial view has been disclosed in Korean Patent Application Publication No. 2008-0024772.

However, this technology has a problem in that it is impossible to display objects outside of the current visual field of the camera. For example, when a vehicle is driven backward for parking, the parking lines in areas that the vehicle has already passed (outside of the current visual field) cannot be displayed.

Accordingly, there is a need for a technology that can create an image for displaying objects outside of the current visual field of the camera. Further, it is necessary to consider a measure that can minimize system load and support an accurate and quick processing speed when developing this technology.

### BRIEF SUMMARY

Accordingly, the present disclosure keeps in mind the above problems occurring in the prior art. An object of this disclosure is to make it possible to display objects outside of the current visual field of a camera by combining aerial views of images of the area around a vehicle that are taken at different times by a camera.

Another object of the present disclosure is to make it possible to prevent system load and allow for quick combination by using a wheel pulse sensor in a vehicle when combining aerial views of images of the area around a vehicle that are taken at different times by a camera.

Another object of the present disclosure is to make it possible to prevent system load and allow for quick combination by using a wheel pulse sensor and a steering wheel sensor in a vehicle when combining aerial views of images of the area around a vehicle that are taken at different times by a camera.

In order to accomplish the above object, the present disclosure provides an apparatus for creating an image of an area around a vehicle, the apparatus including: an aerial-view image creation unit that creates an aerial-view image by converting an image of an area around a vehicle, which is taken by a camera unit mounted on the vehicle, into data on a ground coordinate system projected with the camera unit as a visual point; a movement information extraction unit that extracts information about movement of the vehicle on the basis of wheel pulses for a left wheel and a right wheel of the vehicle, the wheel pulses created on the basis of the amount of rotation of the wheels of the vehicle by a wheel pulse sensor in the vehicle; a movement-area aerial-view image creation unit that creates a movement-area aerial-view image, which is an aerial view of the area to which the vehicle has moved, by matching a previous aerial-view image created by the aerial-view image creation unit to the movement information; and a combined aerial-view image creation unit that combines an aerial-view image, which is created after the previous aerial-view image is created, with the movement-area aerial-view image.

The movement information extraction unit may include a movement distance extractor that extracts a movement distance of the vehicle on the basis of the average of the wheel pulse for the left wheel and the wheel pulse for the right wheel.

The movement information extraction unit may include a pulse-based turning radius extractor that extracts a turning radius of the vehicle on the basis of the difference between the wheel pulses for the left wheel and the right wheel.

The movement information extraction unit may include a pulse-based movement position extractor that extracts a position to which the vehicle has moved, on the basis of the turning radius extracted by the pulse-based turning radius extractor and the movement distance extracted by the movement distance extractor.

The movement information extraction unit may include a steering-based turning radius extractor that senses a steering rotation angle of the vehicle through a steering wheel sensor in the vehicle and extracts a turning radius of the vehicle by calculating rotational angles of a left front wheel and a right front wheel of the vehicle on the basis of the steering rotation angle.

The movement information extraction unit may include a steering-based movement position extractor that extracts a position to which the vehicle has moved, on the basis of the turning radius extracted by the steering-based turning radius extractor and the movement distance extracted by the movement distance extractor.

The movement information extraction unit may include a gear-based extraction instructor that gives an instruction to extract information about movement of the vehicle when the vehicle is moving backward by checking gears of the vehicle.

The gear-based extraction instructor may extract a change in the traveling direction of the vehicle by analyzing a change in the pattern of the wheel pulses for the left wheel and the right wheel when the vehicle is in a neutral gear.

The change in the traveling direction of the vehicle may be extracted by analyzing the change in pattern of a rising edge or a falling edge of a wheel pulse repeated between the left wheel and the right wheel.

In order to accomplish the above object, the present disclosure provides a method of creating an image of the area around a vehicle, the method including: creating an aerial-view image by converting an image of an area around a vehicle, which is taken by a camera unit mounted on the vehicle, into data on a ground coordinate system projected with the camera unit as a visual point, by means of an aerial-view image creation unit; extracting information about movement of the vehicle on the basis of wheel pulses for a left wheel and a right wheel of the vehicle, the wheel pulses created on the basis of the amount of rotation of the wheels of the vehicle by a wheel pulse sensor in the vehicle, by means of a movement information extraction unit; creating a movement-area aerial-view image, which is an aerial view of the area to which the vehicle has moved, by matching a previous aerial-view image created by the aerial-view image creation unit to the movement information, by means of a movement-area aerial-view image creation unit; and creating a combined aerial-view image by combining an aerial-view image, which is created after the previous aerial-view image is created, with the movement-area aerial-view image, by means of a combined aerial-view image creation unit.

The extracting of movement information may include extracting a movement distance of the vehicle on the basis of the average of the wheel pulse for the left wheel and the wheel pulse for the right wheel.

The extracting of movement information may include extracting a turning radius of the vehicle on the basis of the difference between the wheel pulses for the left wheel and the right wheel.

The extracting of movement information may include extracting a position to which the vehicle has moved, on the basis of the turning radius extracted in the extracting of a turning radius and the movement distance extracted in the extracting of a movement distance.

The extracting of movement information may include sensing a steering rotation angle of the vehicle through a steering wheel sensor in the vehicle, and extracting a turning radius of the vehicle by calculating rotational angles of a left front wheel and a right front wheel of the vehicle on the basis of the steering rotation angle.

The extracting of movement information may include extracting a position to which the vehicle has moved, on the basis of the turning radius extracted in the extracting of a turning radius and the movement distance extracted in the extracting of a movement distance.

The method may further include giving an instruction to extract the information about movement of the vehicle when the vehicle is moving backward by checking gears in the vehicle, after the creating of a previous aerial-view image.

The giving of an instruction may extract a change in traveling direction of the vehicle by analyzing a change in pattern of the wheel pulses for the left wheel and the right wheel when the vehicle is in a neutral gear.

A change in traveling direction of the vehicle may be extracted by analyzing a change in a pattern of a rising edge or a falling edge of a wheel pulse repeated between the left wheel and the right wheel.

According to the present disclosure, it is possible to display objects outside of the current visual field of a camera by combining aerial views of images around a vehicle that are taken at different times by a camera.

Further, according to the present disclosure, it is possible to prevent system load and allow for quick combination by using a wheel pulse sensor in a vehicle when combining aerial views of images around a vehicle that are taken at different times by a camera.

Further, according to the present disclosure, it is possible to prevent system load and allow for quick combination by using a wheel pulse sensor and a steering wheel sensor in a vehicle when combining aerial views of images around a vehicle that are taken at different times by a camera.

### BRIEF DESCRIPTION OF THE DRAWINGS

FIG. 1 is a schematic view showing the main parts of an apparatus for creating an image of the area around a vehicle according to the present disclosure.

FIG. 2 is a block diagram of an apparatus for creating an image of the area around a vehicle according to the present disclosure.

FIG. 3 is a view showing a positional relationship in coordinate conversion performed by an apparatus for creating an image of the area around a vehicle according to the present disclosure.

FIG. 4 is a view for illustrating the concept of an apparatus for creating an image of the area around a vehicle according to the present disclosure.

FIGS. 5 to 10 are views showing a process that is performed by an apparatus for creating an image of the area around a vehicle according to the present disclosure.

FIG. 11 is a view showing a first embodiment of a movement information extraction unit that is a component of an apparatus for creating an image of the area around a vehicle according to the present disclosure.

FIG. 12 is a view showing a wheel pulse for the left rear wheel of a vehicle created by an apparatus for creating an image of the area around a vehicle according to the present disclosure.

FIG. 13 is a view showing a wheel pulse for the right rear wheel of a vehicle created by an apparatus for creating an image of the area around a vehicle according to the present disclosure.

FIG. 14 is a view for illustrating a method of extracting a movement position of a vehicle in accordance with the first embodiment of a movement information extraction unit.

FIG. 15 is a view showing a second embodiment of a movement information extraction unit that is a component of an apparatus for creating an image of the area around a vehicle according to the present disclosure.

FIG. 16 is a view for illustrating a steering wheel sensor according to the second embodiment of a movement information extraction unit.

FIG. 17 is a view for illustrating a method of calculating rotational angles of the left front wheel and the right front wheel of a vehicle in accordance with the second embodiment of a movement information extraction unit.

FIG. 18 is a view for illustrating a method of extracting a movement position of a vehicle in accordance with the second embodiment of a movement information extraction unit.

FIG. 19 is a view for illustrating a method of extracting a change in traveling direction of a vehicle by analyzing pattern changes in a wheel pulse for a rear wheel of a vehicle.

FIG. 20 is a view for illustrating a method of extracting a change in traveling direction of a vehicle by analyzing pattern changes in a wheel pulse for a rear wheel of a vehicle.

FIG. 21 is a flowchart of a method of creating an image of the area around a vehicle according to the present disclosure.

FIG. 22 is a view for illustrating a step of giving an instruction to extract information about movement of a vehicle in the method of creating an image of the area around a vehicle according to the present disclosure.

### DETAILED DESCRIPTION

Example embodiments of the present invention will be described hereafter in detail with reference to the accompanying drawings. Repetitive descriptions and well-known functions and configurations that may unnecessarily make the spirit of the disclosure unclear are not described in detail.

The embodiments are provided to more completely explain the present disclosure to those skilled in the art. Therefore, the shapes and sizes of the components in the drawings may be exaggerated for more clear explanation.

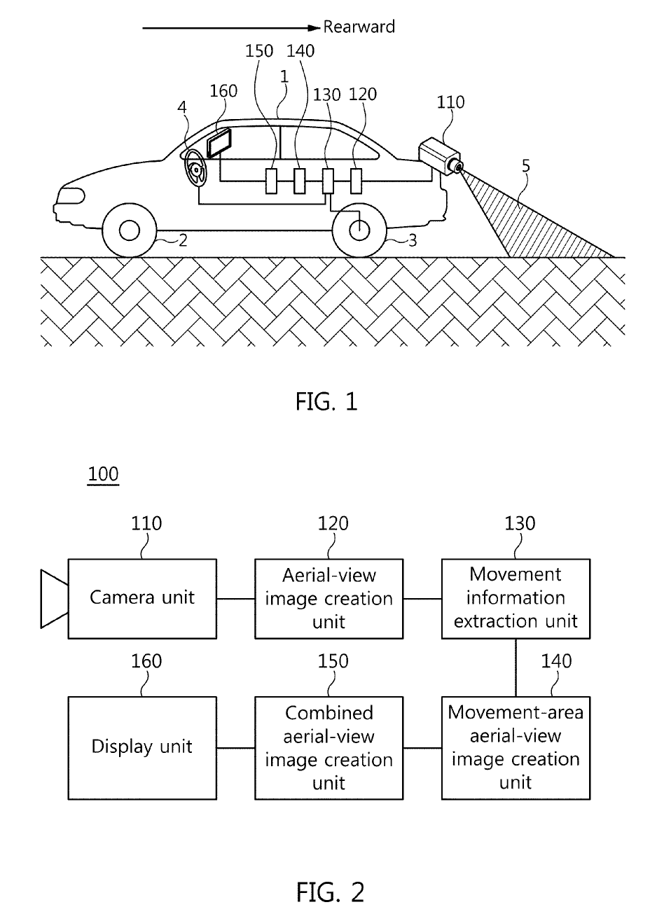

The basic system configuration of an apparatus for creating an image of the area around a vehicle according to the present disclosure is described with reference to FIGS. 1 and 2.

FIG. 1 is a schematic view showing the main parts of an apparatus for creating an image of the area around a vehicle according to the present disclosure. FIG. 2 is a block diagram of an apparatus for creating an image of the area around a vehicle according to the present disclosure.

Referring to FIG. 1, an apparatus 100 for creating an image of the area around a vehicle according to the present disclosure includes: a camera unit 110 that is mounted on a vehicle 1 and creates an image by photographing a peripheral area 5; an aerial-view image creation unit 120 that creates an aerial-view image by converting the taken image into data on a ground coordinate system projected with the camera unit 110 as a visual point; a movement information extraction unit 130 that extracts information about movement of the vehicle on the basis of wheel pulses for a left wheel 3 and a right wheel (not shown) of the vehicle, the wheel pulses created on the basis of the amount of rotation of the wheels of the vehicle by a wheel pulse sensor in the vehicle 1; a movement-area aerial-view image creation unit 140 that creates a movement-area aerial-view image, which is an aerial view of the area that the vehicle 1 moves, by matching the previous aerial-view image created by the aerial-view image creation unit 120 to the movement information; and a combined aerial-view image creation unit 150 that combines an aerial-view image, which is created after the previous aerial-view image is created, with the movement-area aerial-view image.

In addition, the apparatus may further include a display 160 that is mounted in the vehicle 1 and displays the combined aerial-view image.

The aerial-view image creation unit 120, the movement information extraction unit 130, the movement-area aerial-view image creation unit 140, and the combined aerial-view image creation unit 150, which are main parts of the apparatus 100 for creating an image of the area around a vehicle according to the disclosure, are electronic devices for processing image data, including a microcomputer, and may be integrated with the camera unit 110.

The camera unit 110 is mounted on the vehicle 1 and creates an image by photographing the peripheral area 5.

As shown in FIG. 1, the camera unit 110 is disposed on the rear part of the vehicle and includes at least one camera (for example, a CCD camera).

The aerial-view image creation unit 120 creates an aerial-view image by converting the image created by the camera unit 110 into data in a ground coordinate system projected with the camera unit 110 as a visual point.

A well-known method may be used, as will be described below, to convert the image created by the camera unit 110 into an aerial-view image. The position of an image on the ground (for example, showing a parking spot) is obtained as an aerial-view image by performing reverse processing of common perspective conversion.

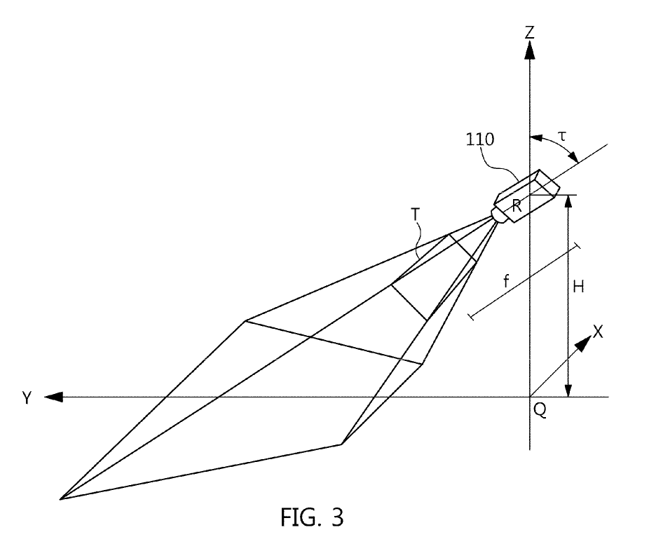

FIG. 3 is a view showing a positional relationship in coordinate conversion that is performed by an apparatus for creating an image of the area around a vehicle according to the present disclosure.

In detail, as shown in FIG. 3, the position data of an image on the ground is projected to a screen plan T having a focal distance f from the position R of the camera unit 110, whereby perspective conversion is performed.

In detail, it is assumed that the camera unit 110 is positioned at a point R (0, 0, H) on the Z-axis and monitors an image on the ground (X-Y plan) at an angle τ. Accordingly, as shown in the following Equation 1, 2-D coordinates (α,β) on the screen plan T can be converted (reversely projected) to coordinates on the ground.

$$[ \begin{matrix}x \\ \\ y\end{matrix} ] = [ \begin{matrix}H \cdot α / ( - β cos τ + f sin τ ) \\ \\ H \cdot ( βsin τ + f cos τ ) / ( - β cos τ + f sin τ )\end{matrix} ] \qquad [ Equation 1 ]$$

That is, by using Equation 1, it is possible to convert projected image (showing an aerial-view image) into an image on the screen of the display unit 160 and then display the converted image on the display unit 160.

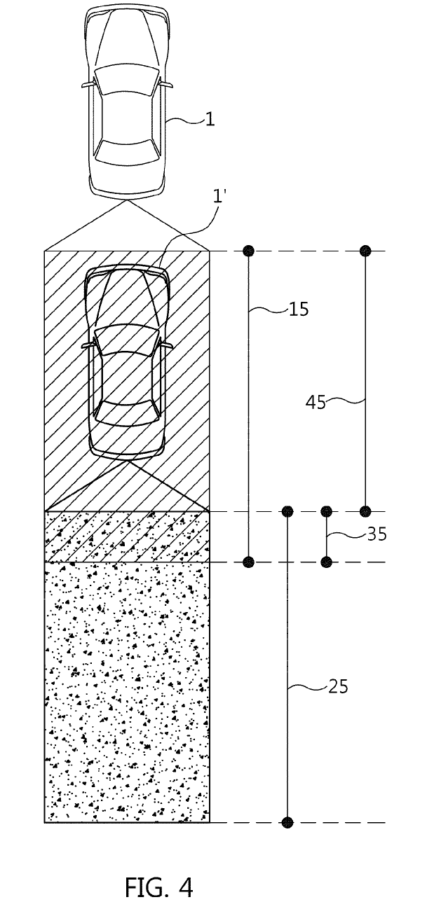

The concept of the apparatus for creating an image of the area around a vehicle according to the present disclosure is described hereafter with reference to FIG. 4.

FIG. 4 shows a vehicle 1 at a time point T and a vehicle 1′ at a time point T+1 after a predetermined time passes from the time point T.

The aerial-view image of the vehicle 1 created at the time point T is referred to as a previous aerial-view image 15 and the aerial-view image of the vehicle 1′ created at the time point T+1 is referred to as a subsequent aerial-view image 25.

The previous aerial-view image 15 and the subsequent aerial-view image 25 have an aerial-view image 35 in the common area. That is, the aerial-view image 35 is an aerial-view image commonly created at the time points T and T+1.

Further, when the vehicle 1′ is seen from a side at the time point T+1, the part except for the aerial-view image 35 in the common area in the previous aerial-view image 15 is a past aerial-view image 45.

The past aerial-view image 45 is an object outside of the visual field of the camera unit 110 on the rear part of the vehicle 1′ at the time point T+1. That is, it means an object that is not photographed at the time point T+1 that is the current time point.

The apparatus 100 for creating an image of the area around a vehicle according to the present disclosure has another object of including the past aerial-view image 45 in the image displayed on the display unit 160 in the vehicle 1′ at the time point T+1. That is, a combined image of the subsequent aerial-view image 25 and the past aerial-view image 45 in the current visual field of the camera unit 110 is displayed.

The combined image is referred to as a combined aerial-view image. In order to create the combined aerial-view image, it is required to accurately combine the subsequent aerial-view image 25 and the past aerial-view image 45 with a high processing speed and minimum system load.

Further, it is required to extract information about movement of the vehicle in order to accurately extract the past aerial-view image 45. The past aerial-view image 45 is obtained by extracting the movement information, so it is also referred to as a movement-area aerial-view image. A detailed method of extracting the information about movement of the vehicle will be described below.

Therefore, the combined aerial-view image means an image that is a combination of the subsequent aerial-view image 25, which is created at the time point T+1 after the previous aerial-view image 15 is created at the time point T, and the movement-area aerial-view image.

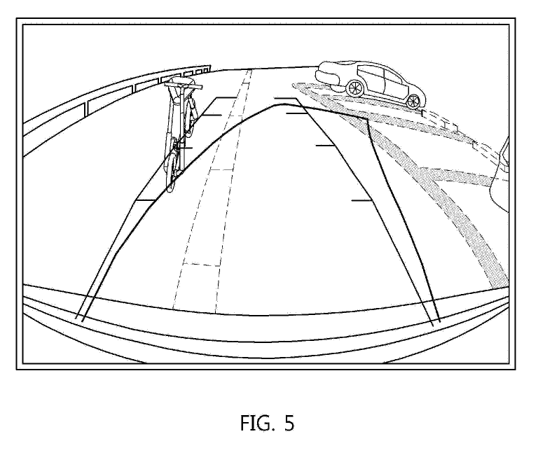

Hereafter, the operation of the movement information extraction unit 130, the movement-area aerial-view image creation unit 140, and the combined aerial-view image creation unit 150 is described with reference to FIGS. 5 to 10.

FIGS. 5 to 10 are views showing the process that is performed by the apparatus for creating an image of the area around a vehicle according to this disclosure.

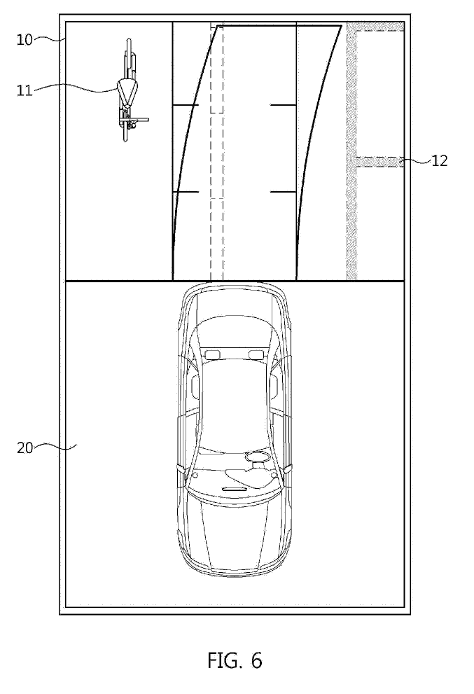

FIG. 5 shows an image taken by the camera unit 110 and displayed on the display unit 160 and FIG. 6 shows an aerial-view image 10 (hereafter, referred to as a previous aerial-view image) converted from the image shown in FIG. 5 by the aerial-view image creation unit 120 and then displayed on the display unit 160.

Referring to FIG. 5, it can be seen that there is a bicycle 11 and some parking lines 12 behind the vehicle 1. Further, referring to FIG. 6, it can be seen that the image of the bicycle 11 and the parking lines 12 has been converted into an aerial-view image.

Further, referring to FIG. 6, since the camera unit 110 is mounted on the rear part of the vehicle 1, the actual rectangular parking spot is distorted on the display unit, depending on the vehicle 1 and the distance between the camera unit 110 and the parking lines.

Referring to FIG. 6, it can be seen that an aerial-view image is not created for an object 20 outside of the current visual field of the camera unit 110.

Accordingly, a driver cannot see parking lines or objects outside of the current visual field of the camera unit 110 when parking the vehicle, so it is difficult to intuitively recognize the position of the vehicle 1 and an accident may be caused.

The apparatus 100 for creating an image of the area around a vehicle according to the present disclosure has a function of creating an aerial-view image even of the object 20 outside of the current visual field of the camera unit 110 in order to solve this problem.

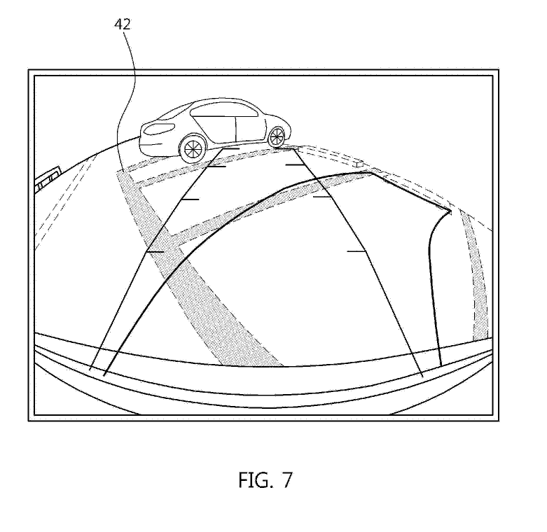

FIG. 7 shows an image taken by the camera unit 110 after the driver of the vehicle turns a steering wheel 4 counterclockwise and drives the vehicle backward a predetermined distance from the space shown in FIG. 5.

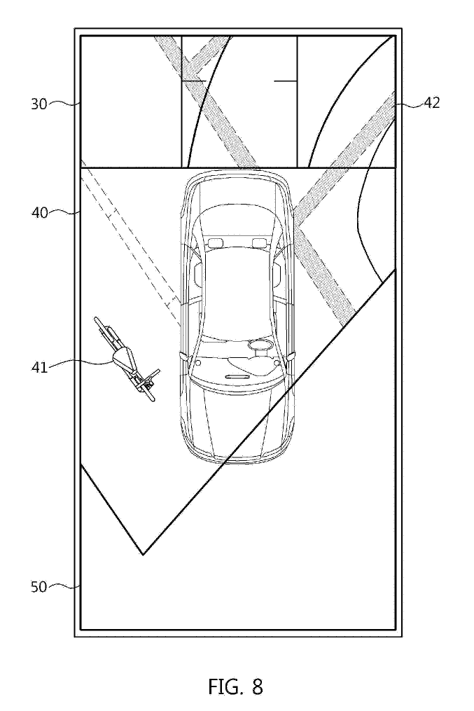

FIG. 8 shows an aerial-view image 30 (hereafter, referred to as a subsequent aerial-view image) converted from the image shown in FIG. 7 by the aerial-view image creation unit 120.

The location of the previous aerial-view image 10 (see FIG. 6) may be included in the subsequent aerial-view image 30, depending on the movement distance of the vehicle 1.

Further, an aerial-view image 40 that is not shown in FIG. 7 is shown in FIG. 8. The aerial-view image 40 not shown in FIG. 7 means an aerial-view image for an object outside of the current visual field of the camera unit 110 on the vehicle. Accordingly, referring to both FIGS. 7 and 8, the bicycle 41 is an object outside of the current visual field of the camera unit 110.

The aerial-view image 40 not shown in FIG. 7 is a virtual image and existed before the vehicle 1 was driven backward, that is, in the previous aerial-view image 10, so even an object that is not in the current visual field of the camera unit 110 can be displayed.

However, there is a part 50 without an aerial-view image, because the part did not exist before the vehicle 1 was driven backward, that is, in the previous aerial-view image. In detail, this is because no images are captured before the vehicle 1 starts to be driven.

As a result, the driver can see both of the subsequent aerial-view image 30 and the aerial-view image 40 not shown in FIG. 7 through the display unit 160.

Accordingly, the driver can check the bicycle 41 and the parking lines 42 outside of the current visual field of the camera unit 110 when driving backward, so it is possible to prevent an accident.

An aerial-view image obtained by combining the subsequent aerial-view image 30 and the aerial-view image 40 not shown in FIG. 7 is referred to as a combined aerial-view image.

However, it is required to extract the past image that is the aerial-view image 40 not shown in FIG. 7 in order to create the combined aerial-view image and it is required to extract the information about movement of the vehicle in order to extract the past image.

The movement information extraction unit 130 extracts the information about movement of the vehicle and the detailed method will be described below.

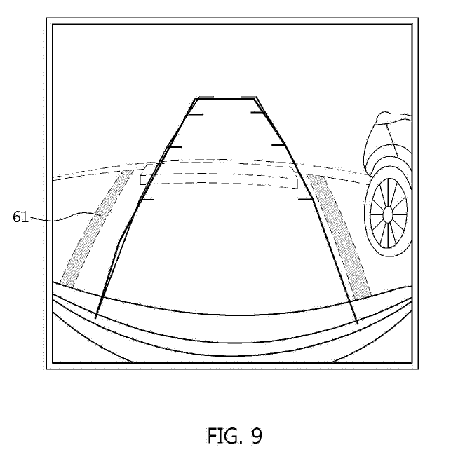

FIG. 9 is an image created by the camera unit 110 after the vehicle moves backward a predetermined distance from the space shown in FIG. 7.

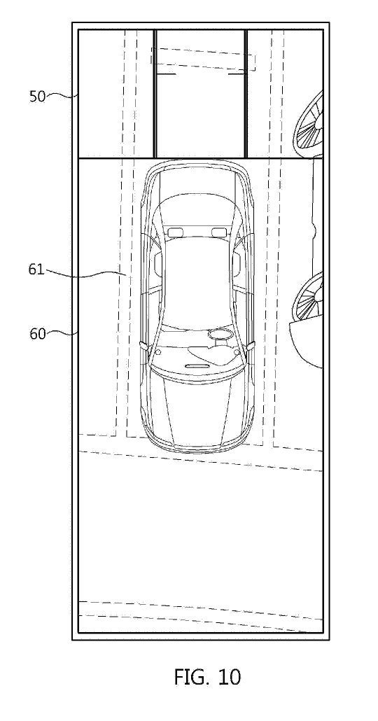

FIG. 10 shows an aerial-view image 50 (hereafter, referred to as a last aerial-view image) converted from the image shown in FIG. 9 by the aerial-view image creation unit 120.

The parts where the previous aerial-view image 10 and the subsequent aerial-view image 30 were may be included in the last aerial-view image 50, depending on the movement distance of the vehicle 1.

Further, an aerial-view image 60 that is not shown in FIG. 9 is shown in FIG. 10. The aerial-view image 60 not shown in FIG. 9 means an aerial-view image of objects not in the current visual field of the camera unit 110 on the vehicle.

The aerial-view image 60 not shown in FIG. 9 is a virtual image and had existed before the vehicle 1 was driven backward, that is, in the previous aerial-view image 10 and the subsequent aerial-view image 30, so even an object that is not in the current visual field of the camera unit 110 can be displayed.

Accordingly, the driver can see both the last aerial-view image 50 and the aerial-view image 60 not shown in FIG. 9 through the display unit 160.

As a result, the driver can check parking lines 42 outside of the current visual field of the camera unit 110 when driving backward, so it is possible to prevent an accident.

An aerial-view image obtained by combining the last aerial-view image 50 and the aerial-view image 60 not shown in FIG. 9 is referred to as a combined aerial-view image.

However, it is required to extract the past image that is the aerial-view image 60 not shown in FIG. 9 in order to create the combined aerial-view image and it is required to extract the information about movement of the vehicle in order to extract the past image.

The movement information extraction unit 130 extracts the information about movement of the vehicle and the detailed method will be described below.

Hereafter, the function of the movement information extraction unit 130 that is a component of the apparatus 100 for creating an image of the area around a vehicle according to the present disclosure is described, and first and second embodiments that are various embodiments of the movement information extraction unit 130 are described in detail.

The movement information extraction unit 130 extracts information about movement of the vehicle on the basis of wheel pulses for a left wheel 3 and a right wheel (not shown) of the vehicle, in which the wheel pulses are obtained on the basis of the amount of rotation of wheels of the vehicle by a wheel pulse sensor in the vehicle 1.

The front wheels 2 of the vehicle 1 are rotated differently from the rear wheels of the vehicle 1, so it is more effective to use the rear wheels of the vehicle 1 in order to accurately extract the movement distance of the vehicle 1.

Accordingly, a rear wheel is mainly addressed to describe the movement information extraction unit 130. However, this description does not limit the scope of the present disclosure to processing of the rear wheel by the movement information extraction unit 130.

Further, there is a method that uses a yaw rate sensor and a vehicle speed sensor in the related art to extract the information about movement of the vehicle 1, but the related art has a limit as to the accuracy of the extracted information about movement of the vehicle when the vehicle 1 is continuously moving, for example, when it is being parked or driven backward, as in embodiments of the present disclosure.

Accordingly, the present disclosure provides a technology that extracts information about movement of the vehicle on the basis of wheel pulses for a left wheel 3 and a right wheel (not shown) of the vehicle, in which the wheel pulses are obtained on the basis of the amount of rotation of wheels of the vehicle by a wheel pulse sensor in the vehicle 1.

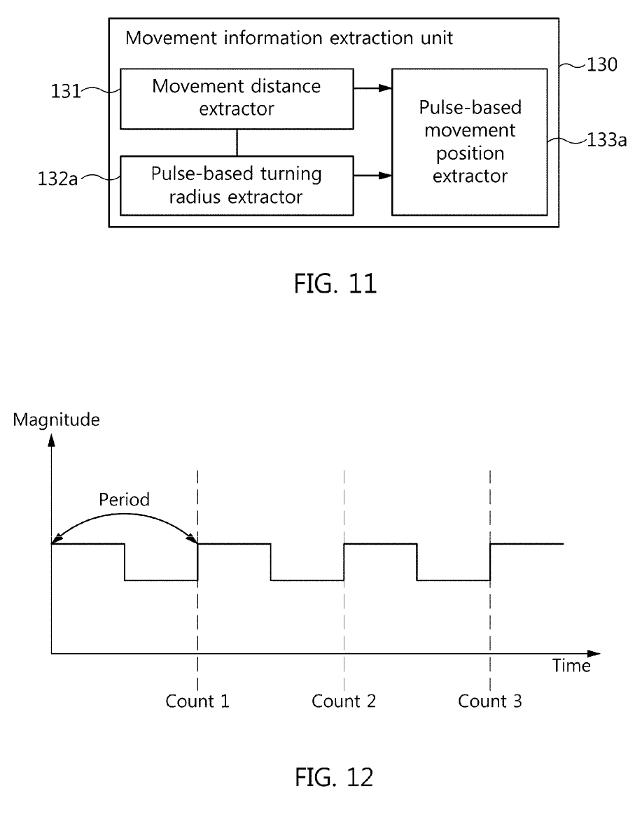

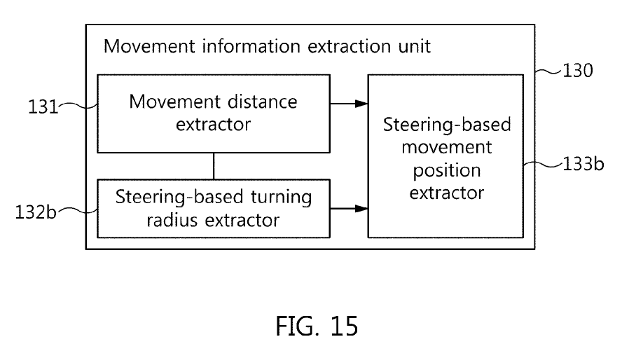

FIG. 11 is a view showing a first embodiment of a movement information extraction unit that is a component of an apparatus for creating an image of the area around a vehicle according to the present disclosure. FIG. 15 is a view showing a second embodiment of a movement information extraction unit that is a component of an apparatus for creating an image of the area around a vehicle according to the present disclosure.

Referring to FIG. 11, a movement information extraction unit 130 according to the first embodiment includes a movement distance extractor 131, a pulse-based turning radius extractor 132a, and a pulse-based movement position extractor 133a.

Referring to FIG. 15, a movement information extraction unit 130 according to the first embodiment includes a movement distance extractor 131, a steering-based turning radius extractor 132b, and a steering-based position extractor 133b.

The movement distance extractor 131 included in both of the movement information extractors 130 according to the first and second embodiments is described first, after which the first and second embodiments are described separately in detail.

### 1. Movement Distance Extractor 131

The movement distance extractor 131 extracts information about movement of the vehicle on the basis of the average of the wheel pulse for a left wheel and the wheel pulse for a right wheel obtained by a wheel pulse sensor in the vehicle 1.

The wheel pulse sensor is mounted in the vehicle 1 and generates wheel pulse signals, depending on the movement of left wheels and right wheels of the vehicle 1.

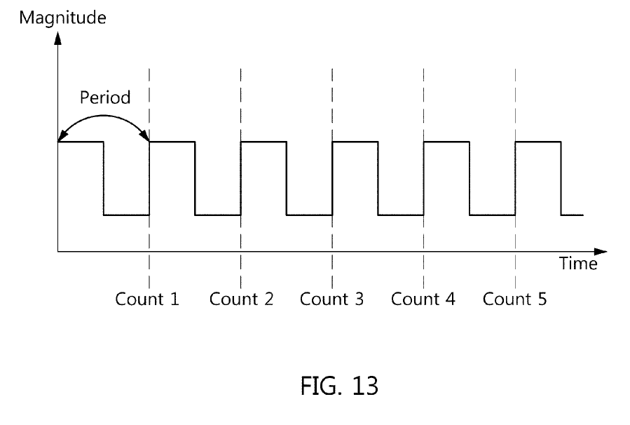

FIG. 12 is a view showing a wheel pulse for the left rear wheel of a vehicle created by an apparatus for creating an image of the area around a vehicle according to the present disclosure. FIG. 13 is a view showing a wheel pulse for the right rear wheel of a vehicle created by an apparatus for creating an image of the area around a vehicle according to the present disclosure.

Changes in a wheel pulse signal for a left rear wheel of the vehicle 1 over time can be seen from FIG. 12. One is counted at each period of the wheel pulse signal, and the distance per period is 0.0217 m.

Similarly, changes in a wheel pulse signal for a right rear wheel of the vehicle 1 over time can be seen from FIG. 13. One is counted at each period of the wheel pulse signal, and the distance per period is 0.0217 m.

In detail, referring to FIGS. 12 and 13, the wheel pulse signal for the left rear wheel at the time point T has a count value of 3 because three periods are counted, but the wheel pulse signal for the right rear wheel has a count value of 5 because five periods are counted.

That is, it can be seen that the right rear wheel has moved a longer distance during the same time. Accordingly, it may be possible to determine that the vehicle 1 is driven backward with the steering wheel turned clockwise, assuming that the vehicle 1 is being driven backward. The method of determining whether a vehicle is being driven forward or backward will be described below.

It is possible to extract the movement distance of the vehicle on the basis of the wheel pulses for the left rear wheel and the right rear wheel shown in FIGS. 12 and 13, using the following Equations 2 to 4.

K1=(WPᵢₙ(t+Δt)−WPᵢₙ(t))×WPᵣₑₛ [Equation 2]

In Equation 2, K1 is the movement distance of the inner rear wheel. For example, when the vehicle 1 is driven backward with the steering wheel turned clockwise, the right rear wheel is the inner rear wheel, but when the vehicle 1 is driven backward with the steering wheel turned counterclockwise, the left rear wheel is the inner rear wheel.

Further, WPᵢₙ is a wheel pulse count value of the inner rear wheel and WPᵣₑₛ is the resolution of a wheel pulse signal, in which the movement distance per period signal is 0.0217 m. That is, WPᵣₑₛ is a constant 0.0217, which may be changed in accordance with the kind and setting of the wheel pulse sensor.

Further, t is the time before the vehicle is moved and Δt is the time taken while the vehicle is moved.

K2γ(WPₒᵤₜ(t+Δt)−WPₒᵤₜ(t))×WPᵣₑₛ [Equation 3]

In Equation 3, K2 is the movement distance of the outer rear wheel.

For example, when the vehicle 1 is driven backward with the steering wheel turned clockwise, the left rear wheel is the outer rear wheel, but when the vehicle 1 is driven backward with the steering wheel turned counterclockwise, the right rear wheel is the outer rear wheel.

Further, WPₒᵤₜ is a wheel pulse count value of the outer rear wheel and WPᵣₑₛ is the resolution of a wheel pulse signal, in which the movement distance per period signal is 0.0217 m. That is, WPᵣₑₛ is a constant of 0.0217, which may be changed in accordance with the kind and setting of the wheel pulse sensor.

Further, t is the time before the vehicle is moved and Δt is the time taken while the vehicle is moved.

$$K = \frac{{K}_{1} + {K}_{2}}{2} \qquad [ Equation 4 ]$$

In Equation 4, K is the movement distance of an axle. The movement distance of an axle is the same as the movement distance of the vehicle.

Further, K₁ is the movement distance of the inner rear wheel and K₂ is the movement distance of the outer rear wheel. That is, the movement distance of the axle that is the movement distance of the vehicle is the average of the movement distance of the inner wheel of the vehicle and the movement distance of the outer wheel of the vehicle.

Accordingly, the movement distance extractor 131 can extract the movement distance of the vehicle 1 through Equations 2 to 4.

### 2. First Embodiment

A method of extracting the turning radius of the vehicle 1 and the coordinates of the movement position in accordance with the first embodiment, using the movement distance of the vehicle 1 extracted by the movement distance extractor 131 is described.

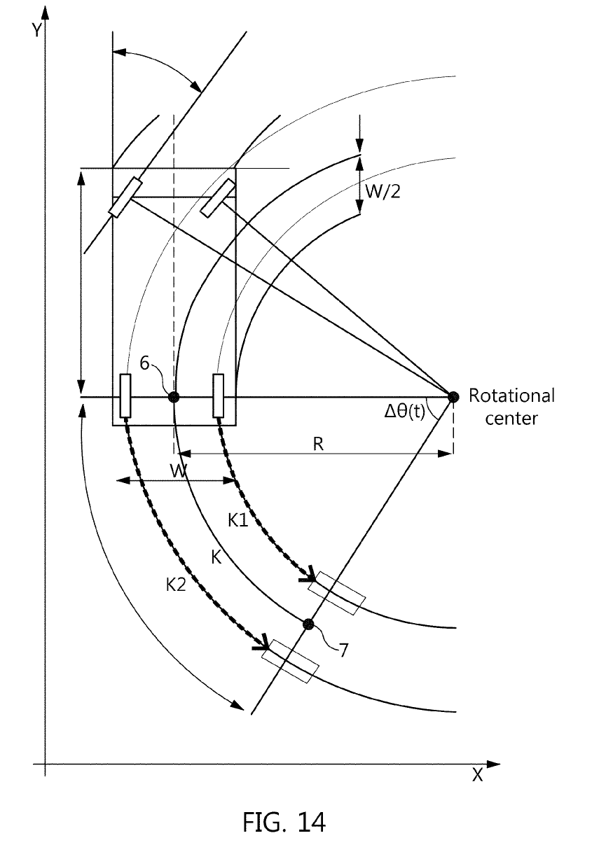

FIG. 14 is a view for illustrating a method of extracting a movement position of a vehicle in accordance with the first embodiment of a movement information extractor.

Referring to FIG. 14, the current position 6 of the vehicle is the center between the left rear wheel and the right rear wheel and is the same as the current center position of the axle. Further, it can be seen that the position 7 after the vehicle 1 is moved is the center between the left rear wheel and the right rear wheel of the vehicle at the movement position.

The pulse-based turning radius extractor 132a extracts the turning radius of the vehicle on the basis of the difference between the wheel pulses of the left rear wheel and the right rear wheel. The method of extracting the turning radius may use the following Equations 5 to 8.

$${K}_{1} = ( R - \frac{W}{2} ) Δ θ ( t ) \qquad [ Equation 5 ]$$

In Equation 5, K₁ is the movement distance of the inner rear wheel and R is the turning radius of the vehicle. In detail, the turning radius means the turning radius of the axle.

W is the width of the vehicle. In detail, W is the distance between the left rear wheel and the right rear wheel. Further, Δθ(t) is variation in the angle of the vehicle during time t.

$${K}_{2} = ( R + \frac{W}{2} ) Δ θ ( t ) \qquad [ Equation 6 ]$$

In Equation 6, K₂ is the movement distance of the outer rear wheel and R is the turning radius of the vehicle. In detail, the turning radius means the turning radius of the axle.

Further, W is the width of the vehicle and Δθ(t) is variation in the angle of the vehicle during time t.

K₂−K₁=WΔθ(t) [Equation 7]

In Equation 7, K₂ is the movement distance of the outer rear wheel and K₁ is the movement distance of the inner rear wheel. Further, W is the width of the vehicle and Δθ(t) is variation in the angle of the vehicle during time t.

$$Δ θ ( t ) = \frac{{K}_{2} - {K}_{1}}{W} \qquad [ Equation 8 ]$$

Equation 8 is obtained by rearranging Equation 7 about Δθ(t) that is the variation in the angle of the vehicle during time t.

That is, Δθ(t) that is the variation of the angle of the vehicle for time t can be obtained by dividing the value, obtained by subtracting K₁ obtained in Equation 6 from K₂ obtained in Equation 5, by the predetermined W that is the width of the vehicle.

Accordingly, all of K₁, K₂, Δθ(t), and W can be found, so R that is the turning radius of the vehicle can be obtained by substituting the values into Equation 5 or 6.

The pulse-based movement position extractor 133a extracts the movement position of the vehicle on the basis of the turning radius extracted by the pulse-based turning radius extractor 132a and the movement distance extracted by the movement distance extractor 131. The method of extracting the turning radius may use the following Equations 9 to 17.

x_{c}(t)=x(t)+R cos θ(t) [Equation 9]

In Equation 9, x_{c}(t) is the position of the x-coordinate of a rotational center and x(t) is the position of the x-coordinate of the current center position of the axle that is the current position of the vehicle. The current center position of the axle means the center position between the left rear wheel and the right rear wheel, which was described above. Further, θ(t) is the current angle of the vehicle.

y_{c}(t)=y(t)+R sin θ(t) [Equation 9]

In Equation 10, y_{c}(t) is the position of the y-coordinate of a rotational center and y(t) is the position of the x-coordinate of the current center position of the axle that is the current position of the vehicle. Further, θ(t) is the current angle of the vehicle.

x′(t)=x(t)−x_{c}(t)=−R cos θ(t) [Equation 11]

In Equation 11, x′(t) is the position of the x-coordinate of the current center position of the axle when the rotational center is the origin and x(t) is the position of the x-coordinate of the current center position of the axle that is the current position of the vehicle. Further, θ(t) is the current angle of the vehicle.

y′(t)=y(t)−y_{c}(t)=−R sin θ(t) [Equation 12]

In Equation 12, y′(t) is the position of the x-coordinate of the current center position of the axle when the rotational center is the origin and y(t) is the position of the y-coordinate of the current center position of the axle that is the current position of the vehicle. Further, θ(t) is the current angle of the vehicle.

$$( \begin{matrix}{x}^{′} ( t + Δ t ) \\ {y}^{′} ( t + Δ t )\end{matrix} ) = ( \begin{matrix}cos Δ θ ( t ) & - sin Δ θ ( t ) \\ sin Δ θ ( t ) & cos Δ θ ( t )\end{matrix} ) ( \begin{matrix}{x}^{′} ( t ) \\ {y}^{′} ( t )\end{matrix} ) \qquad [ Equation 13 ]$$

In Equation 13, x′(t+Δt) is the position of the x-coordinate of the center position after the axle is moved when the rotational center is the origin and y′(t+Δt) is the position of the y-coordinate of the center position after the axle is moved when the rotational center is the origin.

Further, Δθt is variation in the angle of the vehicle during time t, x′(t) is the position of the x-coordinate of the current center position of the axle when the rotational center is the origin, and y′(t) is the position of the y-coordinate of the current center position of the axle when the rotational center is the origin.

That is, Equation 13 is a rotation conversion equation for calculating the center position of the axle that has moved during time Δt, when the rotational center is the origin.

x(t+Δt)=x′(t+Δt)+x_{c}(t) [Equation 14]

In Equation 14, x(t+Δt) is the position of the x-coordinate of the center position after the axle is moved. That is, it does not mean the value of an absolute position, but means a position determined without considering the rotational center as the origin. Further, x′(t+Δt) is the position of the x-coordinate of the center position after the axle is moved when the rotational center is the origin and x_{c}(t) is the position of the x-coordinate of the rotational center.

y(t+Δt)=y′(t+Δt)+y_{c}(t) [Equation 15]

In Equation 15, y(t+Δt) is the position of the y-coordinate of the center position after the axle is moved. That is, it does not mean the value of an absolute position, but means a position determined without considering the rotational center as the origin.

Further, y′(t+Δt) is the position of the y-coordinate of the center position after the axle is moved when the rotational center is the origin and y_{c}(t) is the position of the y-coordinate of the rotational center.

x(t+Δt)=x(t)+R(cos θ(t)−cos Δθ(t)cos θ(t)+sin Δθ(t)sin θ(t)) [Equation 16]

Equation 16 is obtained by substituting Equations 9 to 13 into Equation 14 and is the final equation capable of obtaining x(t+Δt) that is the position of the x-coordinate of the center position after the axle is moved.

y(t+Δt)=y(t)+R(sin θ(t)−sin Δθ(t)cos θ(t)−cos Δθ(t)sin θ(t)) [Equation 17]

Equation 17 is obtained by substituting Equations 9 to 13 into Equation 15 and is the final equation capable of obtaining y(t+Δt) that is the position of the y-coordinate of the center position after the axle is moved.

As described above, the pulse-based movement position extractor 133a can extract the center position of the axle that has moved, using Equations 9 to 17.

### 3. Second Embodiment

A method of extracting the turning radius of the vehicle 1 and the coordinates of the movement position in accordance with the second embodiment, using the movement distance of the vehicle 1 extracted by the movement distance extractor 131 is described.

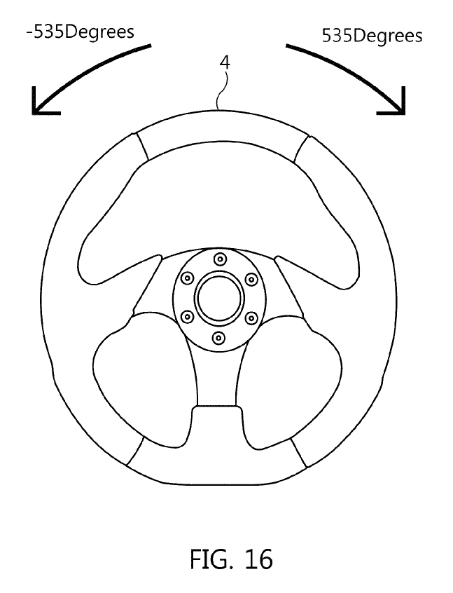

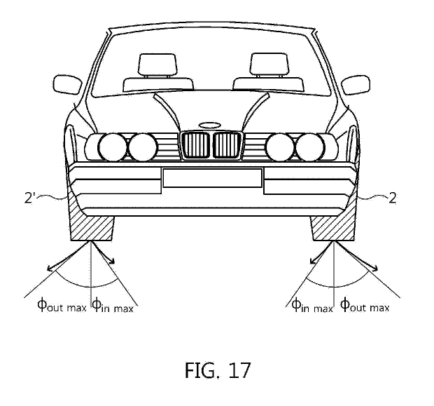

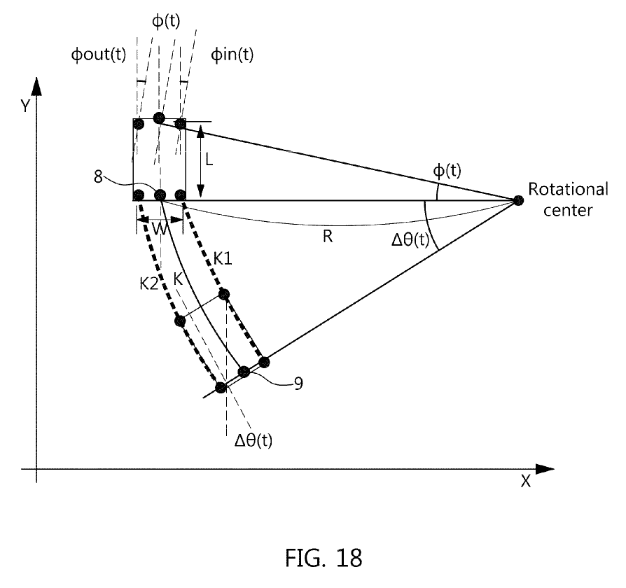

FIG. 16 is a view for illustrating a steering wheel sensor according to the second embodiment of a movement information extraction unit. FIG. 17 is a view for illustrating a method of calculating rotational angles of the left front wheel and the right front wheel of a vehicle in accordance with the second embodiment of a movement information extraction unit. FIG. 18 is a view for illustrating a method of extracting a movement position of a vehicle in accordance with the second embodiment of a movement information extraction unit.

The maximum angle of the steering wheel of the vehicle 1 can be seen from FIG. 16. In detail, it can rotate up to 535 degrees counterclockwise (that is, −535 degrees) and 535 degrees clockwise. The steering wheel sensor in the vehicle 1 is used to sense the angle of the steering wheel.

Referring to FIG. 17, the angles of a left front wheel 2 and a right front wheel 2′ of a vehicle can be seen. In this case, the maximum outer angle φ_{out max} is 33 degrees and the maximum inner angle φ_{in max} is 39 degrees. However, the maximum outer and inner angles may depend on the kind of the vehicle and technological development.

The steering-based turning radius extractor 132b senses the rotational angle of the steering wheel 4 (FIG. 16) of the vehicle through the steering wheel sensor in the vehicle 1 and calculates the rotational angles of the left front wheel 2 and the right front wheel 2′ of the vehicle on the basis of the rotational angle of the steering wheel 4, thereby extracting the turning radius of the vehicle 1.

That is, the steering-based turning radius extractor 132b can sense the angle of the steering wheel and then calculate the angles of the front wheels 2 and 2′ of the vehicle on the basis of the angle of the steering wheel. A detailed method of obtaining the angles of the front wheels 2 and 2′ of the vehicle 1 uses the following Equations.

$$\begin{matrix}{φ}_{out} = {W}_{data} \times \frac{{φ}_{out ma x}}{5350} = {W}_{data} \times \frac{33}{5350} & [ Equation 18 ] \\ {φ}_{i n} = {W}_{data} \times \frac{{φ}_{i n ma x }}{5350} = {W}_{data} \times \frac{39}{5350} & [ Equation 19 ]\end{matrix}$$

In Equations 18 and 19, φₒᵤₜ is the angle of the outer side of the front wheel of the vehicle 1 that is being turned and φᵢₙ is the angle of the inner side of the front wheel of the vehicle 1 that is being turned. Further, φ_{out max} is the maximum outer angle is 33 degrees and φ_{in max} is the maximum inner angle is 39 degrees.

In detail, when the vehicle 1 is driven backward with the steering wheel turned clockwise, the angle of the inner side is calculated on the basis of the left front wheel 2 and the angle of the outer side is calculated on the basis of the right front wheel 2′. Further, when the vehicle 1 is driven backward with the steering wheel turned counterclockwise, the angle of the inner side is calculated on the basis of the right front wheel 2′ and the angle of the outer side is calculated on the basis of the left front wheel 2.

Further, W_{data} is a value obtained from the steering sensor, so it has a range of −535 degrees to 535 degrees.

Referring to FIG. 18, the principle by which the steering-based rotational radius extractor 132b extracts the rotational radius of the vehicle can be seen.

Further, the position 8 of the vehicle before moving backward (position coordinates of the axle center) and the position 9 of the vehicle after moving backward (coordinates of the axle center) are shown. It will be described in detail hereafter with reference to FIG. 18 and Equations 20 to 25.

In FIG. 18 and Equations 20 to 25, φᵢₙ(t) is an angular change of the inner side of a front wheel of the vehicle 1 that is being turned and φₒᵤₜ(t) is an angle change of the outer side of the front wheel of the vehicle 1 that is being turned.

Further, L is the distance between a front wheel axle and a rear wheel axle, W is the width of the vehicle, R is the turning radius of the axle center, and φ(t) is the angle of the center of the front wheel axle.

Further, K is the movement distance of the axle. The movement distance of the axle is the same as the movement distance of the vehicle.

Further, K1 is the movement distance of the inner rear wheel and K2 is the movement distance of the outer rear wheel. That is, the movement distance of the axle that is the movement distance of the vehicle 1 is the average of the movement distance of the inner wheel of the vehicle 1 and the movement distance of the outer wheel of the vehicle 1.

A detailed method of obtaining the movement distance of the vehicle 1 was described above in relation to the movement distance extractor 131, so the detailed description is not provided.

$$\begin{matrix}tan {φ}_{i n} ( t ) = \frac{L}{R - \frac{W}{2}} & [ Equation 20 ] \\ tan {φ}_{out} ( t ) = \frac{L}{R + \frac{W}{2}} & [ Equation 21 ] \\ tan φ ( t ) = \frac{L}{R} & [ Equation 22 ] \\ \frac{1}{tan {φ}_{i n} ( t )} + \frac{1}{tan {φ}_{out} ( t )} = \frac{2 R}{L} & [ Equation 23 ] \\ tan φ ( t ) = \frac{2 tan {φ}_{i n} ( t ) tan {φ}_{out} ( t )}{tan {φ}_{i n} ( t ) + tan {φ}_{out} ( t )} & [ Equation 24 ]\end{matrix}$$

Equation 24 is obtained by combining Equation 22 and Equation 23.

$$R = \frac{L}{tan φ ( t )} \qquad [ Equation 25 ]$$

Equation 25 is the final equation for extracting the turning radius of the vehicle 1. As described above, the steering-based turning radius extractor 132b can extract the turning radius of the vehicle 1 using Equations 20 to 25.

The steering-based movement position extractor 133b extracts the movement position of the vehicle 1 on the basis of the turning radius extracted by the steering-based turning radius extractor 132b and the movement distance extracted by the movement distance extractor 131. A detailed extraction method will be described with reference to Equations 16 and 17 and the following Equations 26 and 27.

$$\begin{matrix}K = \frac{{K}_{1} + {K}_{2}}{2} & [ Equation 26 ] \\ Δθ ( t ) = \frac{K}{R} & [ Equation 27 ]\end{matrix}$$

In Equations 26 and 27, Δθ(t) is variation in the vehicle angle for time t, R is the turning radius of the axle, K is the movement distance of the axle, K₂ is the movement distance of the outer rear wheel, and K₁ is the movement distance of the inner rear wheel.

In detail, K₁ and K₂ are extracted by the movement distance extractor 131, K is obtained from Equation 26, and then Δθ(t) can be obtained by substituting the turning radius R extracted by the steering-based turning radius extractor 132b into Equation 27.

Accordingly, the center position after the axle is moved can be extracted by substituting Δθ(t) into Equations 16 and 17.

Hereafter, the movement-area aerial-view image creator 140 and the combined aerial-view image creator 150 are described with reference to FIG. 4.

The movement-area aerial-view image creator 140 creates a movement-area aerial-view image that is an aerial view for the area where the vehicle 1 is moved, on the basis of the information about movement of the vehicle extracted by the movement information extraction unit 130 through the first and second embodiments.

In detail, the past aerial-view image 45 that is the movement-area aerial-view image shown in FIG. 4 is created on the basis of the movement information.

The combined aerial-view image creation unit 150 combines the subsequent aerial-view image 25, which is created after the previous aerial-view image 15 shown in FIG. 4 is created, with the past aerial-view image 45 that is the movement-area aerial-view image.

Accordingly, the driver can see the aerial-view image 45 for the part not photographed by the camera unit 110, even if the vehicle is at the time point T+1 (1′) after moving backward.

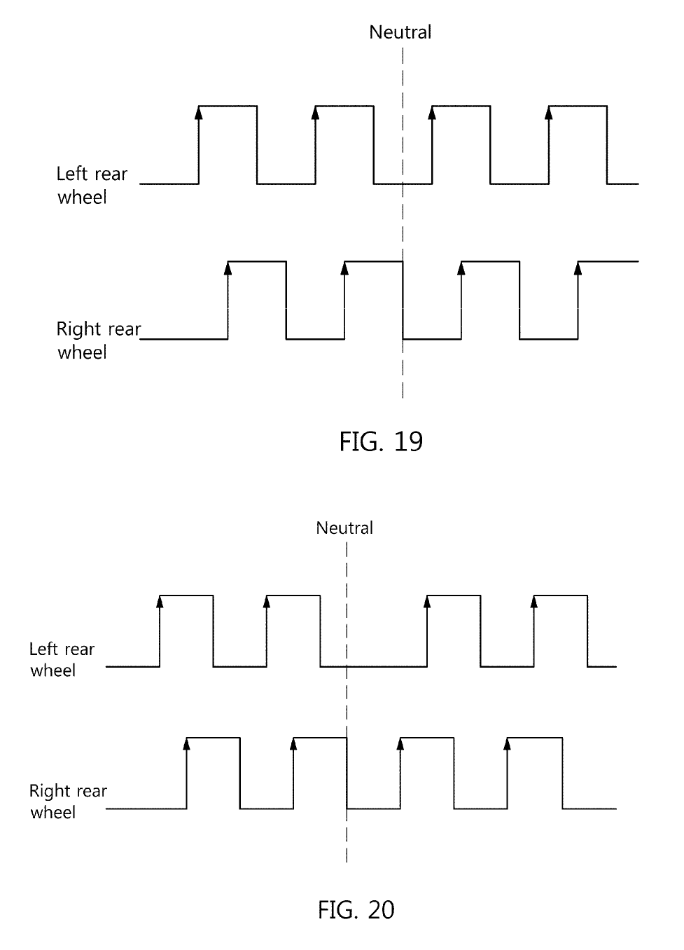

A gear-based extraction instructor and a sensor-based extraction instructor are described hereafter with reference to FIGS. 19 and 20.

FIG. 19 is a view for illustrating a method of extracting a change in the traveling direction of a vehicle by analyzing pattern changes in a wheel pulse for a rear wheel of a vehicle.

FIG. 20 is a view for illustrating a method of extracting a change in the traveling direction of a vehicle by analyzing pattern changes in a wheel pulse for a rear wheel of a vehicle.

When the wheel pulse sensor is designed to be able to sense the traveling direction of the vehicle (the wheel pulse sensor is a directional encoder), the wheel pulse sensor senses the traveling direction of the vehicle, but when the wheel pulse sensor cannot sense the traveling direction of the vehicle, the traveling direction of the vehicle is extracted through the gear-based extraction instructor and the sensor-based extraction instructor which will be described below.

The movement information extraction unit 130 may include a gear-based extraction instructor that gives an instruction to extract the information about movement of the vehicle when the vehicle is being driven backward by checking the gears of the vehicle.

It is possible to check the gears of the vehicle using a sensor or an ECU in the vehicle and it is known in the art, so it is not described in detail herein.

It is possible to extract a change in the traveling direction of the vehicle by analyzing pattern changes in wheel pulses for a left rear wheel and a right rear wheel of the vehicle.

In detail, referring to FIG. 19, for the wheel pulse pattern for the left rear wheel of the vehicle and the wheel pulse pattern for the right rear wheel of the vehicle before the vehicle changes to the neutral gear, it can be seen that a pattern having the order of 1) left rear wheel, 2) right rear wheel, 3) left rear wheel, and 4) right rear wheel from a rising edge is formed. It can be further seen that the pattern having the order of 1) left rear wheel, 2) right rear wheel, 3) left rear wheel, and 4) right rear wheel is maintained after the vehicle changes to the neutral gear.

In general, a vehicle is driven backward with the backward gear engaged, but a vehicle may be moved backward even though the backward gear of the vehicle is not engaged (for example, if the neutral gear is engaged), depending on the slope of a road and the state of the vehicle.

Accordingly, as described above, when the patterns of the wheel pulse signals for the left rear wheel and the right rear wheel are maintained before and after the neutral gear of the vehicle is engaged, it is estimated that the traveling direction of the vehicle has not changed.

For example, for a vehicle that has been moving forward before the neutral gear is engaged, it is estimated that the vehicle keeps moving forward even after the neutral gear is engaged. Further, for a vehicle that was moving backward before the neutral gear is engaged, it is estimated that the vehicle keeps moving backward even after the neutral gear is engaged.

Referring to FIG. 20, for the wheel pulse pattern for the left rear wheel of the vehicle and the wheel pulse pattern for the right rear wheel of the vehicle before the vehicle changes to the neutral gear, it can be seen that a pattern having the order of 1) left rear wheel, 2) right rear wheel, 3) left rear wheel, and 4) right rear wheel from a rising edge is formed. It can be further seen that the pattern is changed to a pattern having the order of 1) right rear wheel, 2) left rear wheel, 3) right rear wheel, and 4) left rear wheel after the vehicle changes to the neutral gear.

That is, in order to make the same pattern before the neutral gear is engaged and after the neutral gear is engaged, the wheel pulse signal (rising edge) of the left rear wheel should be sensed first after the vehicle changes to the neutral gear, but the wheel pulse signal (rising edge) of the right rear wheel is sensed first.

Accordingly, the patterns of the wheel pulse signals for the left rear wheel and the right rear wheel of the vehicle are changed before the vehicle changes to the neutral gear and after the vehicle changes to the neutral gear.

As a result, as described above, when the patterns of the wheel pulse signals for the left rear wheel and the right rear wheel are changed before and after the neutral gear of the vehicle is engaged, it is estimated that the traveling direction of the vehicle has been changed after the vehicle changed to the neutral gear.

For example, for a vehicle that was moving forward before the neutral gear is engaged, it is estimated that the vehicle is moved backward after the neutral gear is engaged. Further, for a vehicle that was moving backward before the neutral gear is engaged, it is estimated that the vehicle moves forward after the neutral gear is engaged.

The analysis of the repeated patterns for the left rear wheel and the right rear wheel was described on the basis of the rising edge, but the changes in pattern may be extracted on the basis of a falling edge.

Further, the movement information extraction unit 130 may include a sensor-based extraction instructor that determines whether the vehicle is moving backward by sensing the weight and acceleration of the vehicle through a gravity sensor or an acceleration sensor in the vehicle, and that gives an instruction to extract the information about movement of the vehicle when it is determined that the vehicle is moving backward.

In detail, the traveling direction of the vehicle 1 is analyzed by comparing the sensed signal and a predetermined signal, using a gravity sensor or an acceleration sensor in the vehicle.

The principle and operation of the gravity sensor or the acceleration sensor are well known in the art, so detailed description is not provided herein.

In this case, there is an advantage in that it is possible to sense that the vehicle is moving backward, even if the forward gear or the neutral gear of the vehicle, rather than the reverse gear, is engaged.

That is, the sensor-based extraction instructor gives an instruction to extract movement information when it is sensed that the vehicle 1 is moving backward.

A method of creating an image of the area around a vehicle according to the present disclosure is described hereafter.

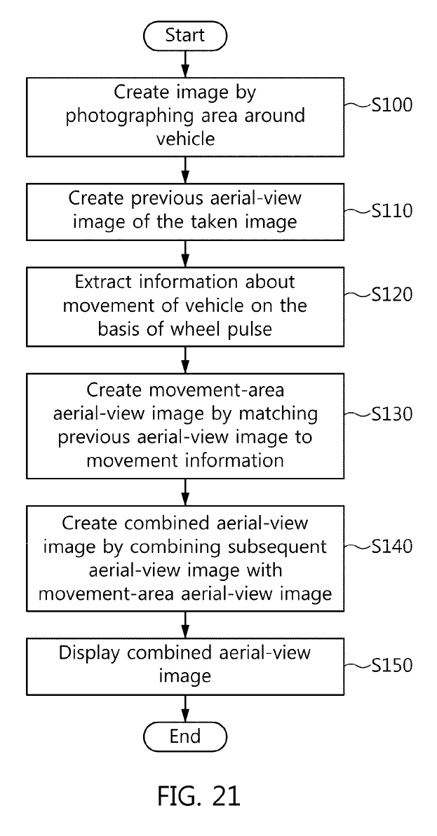

FIG. 21 is a flowchart of a method of creating an image of the area around a vehicle according to the present disclosure.

Referring to FIG. 21, a method of creating an image of the area around a vehicle according to the present disclosure includes: creating an image by photographing a peripheral area of a vehicle using a camera unit on the vehicle (S100); creating an aerial-view image by converting the captured image into data on a ground coordinate system projected with the camera unit as a visual point (S110); extracting information about movement of the vehicle on the basis of wheel pulses for a left wheel and right wheel of the vehicle, the wheel pulses created on the basis of the amount of rotation of the wheels of the vehicle by a wheel pulse sensor in the vehicle (S120); creating a movement-area aerial-view image, which is an aerial view of the area to which the vehicle has moved, by matching the previous aerial-view image to the movement information (S130); and creating a combined aerial-view image by combining an aerial-view image, which is created after the previous aerial-view image is created, with the movement-area aerial-view image (S140).

The method may further include displaying the combined aerial-view image on a display unit in the vehicle (S150) after the creating of a combined aerial-view image (S140).

The method of creating an image of the area around a vehicle according to the present disclosure has configurations corresponding to those of the apparatus 100 for creating an image of the area around a vehicle described above, so they are not described again herein.

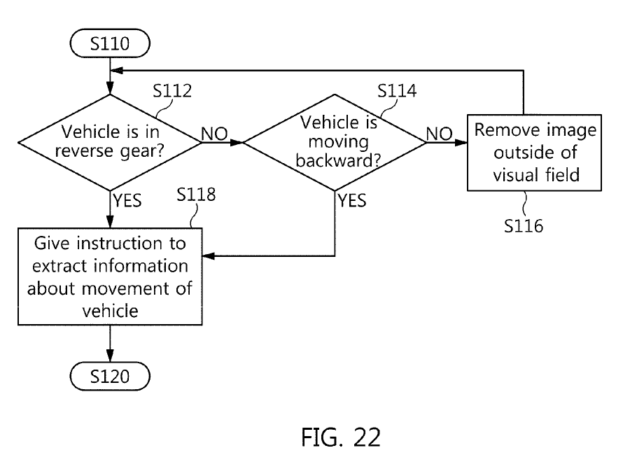

An embodiment of giving an instruction to extract information about movement of a vehicle in the method of creating an image of the area around a vehicle according to the present disclosure is described hereafter with reference to FIG. 22.

Referring to FIG. 22, determining whether the rearward gear is engaged in the vehicle (S112) is performed after the step S110. It is possible to check the gears of the vehicle using a sensor or an ECU in the vehicle and it is known in the art, so it is not described in detail herein.

When it is determined that the rearward gear is engaged in the step S112, giving an instruction to extract information about movement of the vehicle (S118) is performed and the movement information is extracted in the step S120.

However, when it is determined that the rearward gear is not engaged (for example, the forward or neutral gear is engaged) in the step S112, the step S114 is performed, thereby determining whether the vehicle is moving backward.

In order to determine whether the vehicle is moving backward, as described above, it is possible to change the patterns of wheel pulses or use a gravity sensor or an acceleration sensor in the vehicle.

When it is determined that the vehicle is moving backward (that is, the vehicle is moving backward even without the rearward gear engaged), the step S118 is performed, so an instruction to extract the information about movement of the vehicle is given. Accordingly, the movement information can be extracted in the step S120.

However, when it is determined that the vehicle is not moved backward in the step S114, removing an image outside of a visual field (S116) is performed. That is, the reason for this is that the vehicle is moving forward, so there is no need for displaying an image outside of the visual field of the camera on the vehicle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for creating an image of an area around a vehicle, the apparatus comprising:
an aerial-view image creation unit that creates an aerial-view image by converting an image of an area around a vehicle, which is taken by a camera unit mounted on the vehicle, into data on a ground coordinate system projected with the camera unit as a visual point;
a movement information extraction unit that extracts information about movement of the vehicle on the basis of wheel pulses for a left wheel and a right wheel of the vehicle, the wheel pulses created on the basis of the amount of rotation of the wheels of the vehicle by a wheel pulse sensor in the vehicle;
a movement-area aerial-view image creation unit that creates a movement-area aerial-view image, which is an aerial view of the area to which the vehicle has moved, by matching a previous aerial-view image created by the aerial-view image creation unit to the movement information; and
a combined aerial-view image creation unit that combines an aerial-view image, which is created after the previous aerial-view image is created, with the movement-area aerial-view image.

2. The apparatus of claim 1, wherein the movement information extraction unit includes a movement distance extractor that extracts a movement distance of the vehicle on the basis of an average of a wheel pulse for the left wheel and a wheel pulse for the right wheel.

3. The apparatus of claim 2, wherein the movement information extraction unit includes a pulse-based turning radius extractor that extracts a turning radius of the vehicle on the basis of a difference between the wheel pulses for the left wheel and the right wheel.

4. The apparatus of claim 3, wherein the movement information extraction unit includes a pulse-based movement position extractor that extracts a position to which the vehicle has moved, on the basis of the turning radius extracted by the pulse-based turning radius extractor and the movement distance extracted by the movement distance extractor.

5. The apparatus of claim 2, wherein the movement information extraction unit includes a steering-based turning radius extractor that senses a steering rotation angle of the vehicle through a steering wheel sensor in the vehicle and extracts a turning radius of the vehicle by calculating rotational angles of a left front wheel and a right front wheel of the vehicle on the basis of the steering rotation angle.

6. The apparatus of claim 5, wherein the movement information extraction unit includes a steering-based movement position extractor that extracts a position to which the vehicle has moved, on the basis of the turning radius extracted by the steering-based turning radius extractor and the movement distance extracted by the movement distance extractor.

7. The apparatus of claim 1, wherein the movement information extraction unit includes a gear-based extraction instructor that gives an instruction to extract information about movement of the vehicle when the vehicle is moving backward by checking gears of the vehicle.

8. The apparatus of claim 7, wherein the gear-based extraction instructor extracts a change in a traveling direction of the vehicle by analyzing a change in a pattern of the wheel pulses for the left wheel and the right wheel when the vehicle is in a neutral gear.

9. The apparatus of claim 8, wherein a change in the traveling direction of the vehicle is extracted by analyzing a change in pattern of a rising edge or a falling edge of a wheel pulse repeated between the left wheel and the right wheel.

10. A method of creating an image of an area around a vehicle, the method comprising:
creating an aerial-view image by converting an image of an area around a vehicle, which is taken by a camera unit mounted on the vehicle, into data on a ground coordinate system projected with the camera unit as a visual point, by means of an aerial-view image creation unit;
extracting information about movement of the vehicle on the basis of wheel pulses for a left wheel and a right wheel of the vehicle, the wheel pulses created on the basis of the amount of rotation of the wheels of the vehicle by a wheel pulse sensor in the vehicle, by means of a movement information extraction unit;
creating a movement-area aerial-view image, which is an aerial view of the area to which the vehicle has moved, by matching a previous aerial-view image created by the aerial-view image creation unit to the movement information, by means of a movement-area aerial-view image creation unit; and
creating a combined aerial-view image by combining an aerial-view image, which is created after the previous aerial-view image is created, with the movement-area aerial-view image, by means of a combined aerial-view image creation unit.

11. The method of claim 10, wherein the extracting of movement information includes extracting a movement distance of the vehicle on the basis of an average of the wheel pulse for the left wheel and the wheel pulse for the right wheel.

12. The method of claim 11, wherein the extracting of movement information includes extracting a turning radius of the vehicle on the basis of a difference between the wheel pulses for the left wheel and the right wheel.

13. The method of claim 12, wherein the extracting of movement information includes extracting a position to which the vehicle has moved, on the basis of the turning radius extracted in the extracting of a turning radius and the movement distance extracted in the extracting of a movement distance.

14. The method of claim 11, wherein the extracting of movement information includes sensing a steering rotation angle of the vehicle through a steering wheel sensor in the vehicle, and extracting a turning radius of the vehicle by calculating rotational angles of a left front wheel and a right front wheel of the vehicle on the basis of the steering rotation angle.

15. The method of claim 14, wherein the extracting of movement information includes extracting a position to which the vehicle has moved, on the basis of the turning radius extracted in the extracting of a turning radius and the movement distance extracted in the extracting of a movement distance.

16. The method of claim 10, further comprising giving an instruction to extract the information about movement of the vehicle when the vehicle is moving backward by checking gears of the vehicle, after the creating of a previous aerial-view image.

17. The method of claim 16, wherein the giving of an instruction extracts a change in traveling direction of the vehicle by analyzing a change in a pattern of the wheel pulses for the left wheel and the right wheel when the vehicle is in a neutral gear.

18. The method of claim 17, wherein the change in the traveling direction of the vehicle is extracted by analyzing a change in a pattern of a rising edge or a falling edge of a wheel pulse repeated between the left wheel and the right wheel.
